(19) United States
(12) Patent Application Publication
(10) Pub. No.: US 2014/0130968 A1
(43) Pub. Date: May 15, 2014

(54) METHOD FOR FABRICATING A PATTERNED RETARDER

(71) Applicant: FAR EASTERN NEW CENTURY CORPORATION, Taipei City (TW)

(72) Inventors: Wei-Che HUNG, Taipei City (TW); Yu-June Wu, Taipei City (TW); Da-Ren Chiou, Taipei City (TW)

(73) Assignee: FAR EASTERN NEW CENTURY CORPORATION, Taipei City (TW)

(21) Appl. No.: 14/076,947

(22) Filed: Nov. 11, 2013

(30) Foreign Application Priority Data
Nov. 13, 2012 (TW) 101142197

(51) Int. Cl. G02B 5/30

(52) U.S. Cl. CPC G02B 5/3025
USPC 156/247; 156/273.3

(57) ABSTRACT

A method for fabricating a patterned retarder includes bonding first trans-missive substrate that has a patterned photomask layer to a front surface of second light-transmissive substrate, and forming a photo-orientable layer on a rear surface of the second light-transmissive substrate such that a distance between the photomask layer and the photo-orientable layer is relatively small. Linear polarized light is allowed to pass through light-transmissive regions in the photomask unit to irradiate first regions of the photo-orientable layer. Due to the small distance, the polarized light can be either collimated light or uncollimated light.

### CROSS-REFERENCE TO RELATED APPLICATION

This application claims priority of Taiwanese application no. 101142197, filed on Nov. 13, 2012.

### BACKGROUND OF THE INVENTION

1. Field of the Invention

This invention relates to a method for fabricating a patterned retarder, more particularly to a method for fabricating a patterned retarder having two different states of orientation. Such a patterned retarder has many applications, such as in three-dimensional displays.

2. Description of the Related Art

Three dimensional (3D) displays can be classified into glasses-type 3D displays and glasses-free-type 3D displays. Although the glasses-free-type 3D displays do not require the use of 3D glasses for viewing images on the 3D displays, they have disadvantages, such as low resolution, low brightness, and a narrow viewing angle, which result in poor image quality and limitation on viewing positions and are difficult to be overcome.

The glasses-type 3D displays require 3D glasses for viewing images thereon and a relatively wide viewing angle and more viewing positions are obtained. Polarized glasses are more popular 3D glasses due to their low manufacturing costs and light weight. In addition, polarized glasses do not have the flicker problem associated with shutter glasses.

The existing polarized glasses use a film having a patterned polarizer or a retarder film for changing the polarization directions of the left and right eye images before providing the left and right eye images to the left and right eyes of the viewer to thereby create a 3D image viewing effect.

European Patent No. EP 0887667 discloses a method of making a patterned retarder. The method involves rubbing an alignment layer in two different directions, and disposing on the alignment layer a birefringent material whose optic axis is aligned by the alignment layer to thereby obtain a patterned retarder that has two different states of orientation. However, there is the problem of electrostatic discharging during the rubbing operation (due to generation of charged particles). In addition, the method requires the use of complicated photolithography techniques, which involve an extraordinarily high precision operation and result in poor yield.

In applicant's co-pending application (Ser. No. 13/617,559), a method for making a retardation film using photo alignment techniques is disclosed. In said co-pending application, a patterned photomask is used to shield predetermined regions of a photo-alignment layer, such that un-shielded regions of the photo-alignment layer are exposed to linearly-polarized ultraviolet light. However, as the patterned photomask is generally a rigid quartz mask, it cannot come into contact with the photo-alignment layer and has to be kept apart therefrom by a predetermined distance, and such distance may result in undesirable exposure of the shielded regions of the photo-alignment layer. Thus, collimated light has to be used for exposure. In addition, use of the rigid quartz mask makes failure in application of the roll to roll process to produce the retardation film efficiently and in large scale and thus, the manufacturing cost would be too high.

### SUMMARY OF THE INVENTION

An object of the present invention is to provide a method for fabricating a patterned retarder.

Accordingly, a method for fabricating a patterned retarder of this invention comprises:
(a) providing a first light-transmissive substrate having two opposite surfaces, any one of the surfaces including a pressure-sensitive adhesive layer which is light-transmissive, any one of the surfaces including a patterned photomask layer having a plurality of light-transmissive regions in linear alignment, and a plurality of light-shielding regions which alternate with the light-transmissive regions;
(b) providing a second light-transmissive substrate having opposite front and rear surfaces;
(c) bonding the front surface of the second light-transmissive substrate to the pressure-sensitive adhesive layer of the first light-transmissive substrate so that the second light-transmissive substrate is attached to the first light-transmissive substrate;
(d) forming a photo-orientable layer on the rear surface of the second light-transmissive substrate;
(e) irradiating the photo-orientable layer with first linearly-polarized ultraviolet light through the second light-transmissive substrate in a direction from the front surface toward the rear surface of the second light-transmissive substrate to cause a plurality of first regions of the photo-orientable layer to be oriented in a first orientation direction by being irradiated with the first linearly-polarized ultraviolet light that passed through the light-transmissive regions while leaving intact a plurality of second regions of the photo-orientable layer, which are shielded by the light-shielding regions;
(f) irradiating the photo-orientable layer with second linearly-polarized ultraviolet light which is different in polarizing direction from the first linearly-polarized ultraviolet light to cause the second regions of the photo-orientable layer to be oriented in a second orientation direction different from the first orientation direction, so as to transform the photo-orientable layer into a photo-alignment layer which has the first and the second regions each having different orientation directions;
(g) applying a layer of liquid crystal material onto the photo-alignment layer to permit a plurality of first liquid crystal regions of the liquid crystal material layer to be superimposed on and aligned by the oriented first regions, respectively, so as to be in a first state of orientation, and to permit a plurality of second liquid crystal regions of the liquid crystal material layer to be superimposed on and aligned by the oriented second regions, respectively, so as to be in a second state of orientation; and
(h) curing the liquid crystal material layer;

wherein the steps (b) and (c) are performed before the step (e).

### BRIEF DESCRIPTION OF THE DRAWINGS

Other features and advantages of the present invention will become apparent in the following detailed description of the preferred embodiments of the invention, with reference to the accompanying drawings, in which:

FIGS. 1 to 7 are schematic side views illustrating consecutive steps of a first preferred embodiment of a method for fabricating a patterned retarder according to the present invention;

FIGS. 8 to 12 are schematic side views illustrating consecutive steps of a second preferred embodiment of a method for fabricating a patterned retarder according to the present invention, without showing steps of applying and curing a layer of liquid crystal material;

FIG. 13 is a schematic side view illustrating a step of irradiating the photo-orientable layer with second linearly-polarized ultraviolet light, which is performed before a step of irradiating the photo-orientable layer with first linearly-polarized ultraviolet light, in a third preferred embodiment of a method for fabricating a patterned retarder according to the present invention.

FIG. 14 is a schematic side view illustrating a step of irradiating the photo-orientable layer with first linearly-polarized ultraviolet light, which is performed after a step of irradiating the photo-orientable layer with second linearly-polarized ultraviolet light, in a third preferred embodiment of a method for fabricating a patterned retarder according to the present invention.

FIG. 15 is a schematic side view illustrating a step of removing the pressure-sensitive adhesive layer from a second light-transmissive substrate, which is performed before a step of irradiating the photo-orientable layer with second linearly-polarized ultraviolet light, in a forth preferred embodiment of a method for fabricating a patterned retarder according to the present invention.

FIG. 16 is a schematic side view illustrating a step of irradiating the photo-orientable layer with second linearly-polarized ultraviolet light, which is performed after a step of removing the pressure-sensitive adhesive layer from a second light-transmissive substrate, in the forth preferred embodiment of a method for fabricating a patterned retarder according to the present invention.

FIG. 17 is a schematic side view illustrating a step of irradiating the photo-orientable layer with second linearly-polarized ultraviolet light, which is performed after a step of providing a second light-transmissive substrate, in a fifth preferred embodiment of a method for fabricating a patterned retarder according to the present invention.

FIG. 18 is a schematic side view illustrating a step of attaching a front surface of the second light-transmissive substrate to the pressure-sensitive adhesive layer of first light-transmissive substrate, which is performed after a step of irradiating the photo-orientable layer with second linearly-polarized ultraviolet light, in the fifth preferred embodiment of a method for fabricating a patterned retarder according to the present invention.

FIG. 19 is a schematic side view illustrating a step of irradiating the photo-orientable layer with first linearly-polarized ultraviolet light, which is performed after a step of attaching a front surface of the second light-transmissive substrate to the pressure-sensitive adhesive layer of first light-transmissive substrate, in a fifth preferred embodiment of a method for fabricating a patterned retarder according to the present invention.

FIG. 20 is a schematic side view illustrating a step of irradiating the photo-orientable layer with second linearly-polarized ultraviolet light in a sixth preferred embodiment of a method for fabricating a patterned retarder according to the present invention.

FIG. 21 is a schematic side view illustrating a step of irradiating the photo-orientable layer with second linearly-polarized ultraviolet light in a seventh preferred embodiment of a method for fabricating a patterned retarder according to the present invention.

FIG. 22 is a schematic side view illustrating a step of irradiating the photo-orientable layer with first linearly-polarized ultraviolet light in a Comparative Example A1 of a method for fabricating a patterned retarder.

FIG. 23 is a schematic side view illustrating a step of irradiating the photo-orientable layer with second linearly-polarized ultraviolet light in a Comparative Example A1 of a method for fabricating a patterned retarder.

FIG. 24 shows a polarized microscope image of the patterned retarder of Example A1; and

FIGS. 25 and 26 respectively show the polarized microscope images of the patterned retarders of Comparative Example C1 and C2.

### DETAILED DESCRIPTION OF THE PREFERRED EMBODIMENTS

Before the present invention is described in greater detail, it should be noted herein that like elements are denoted by the same reference numerals throughout the disclosure.

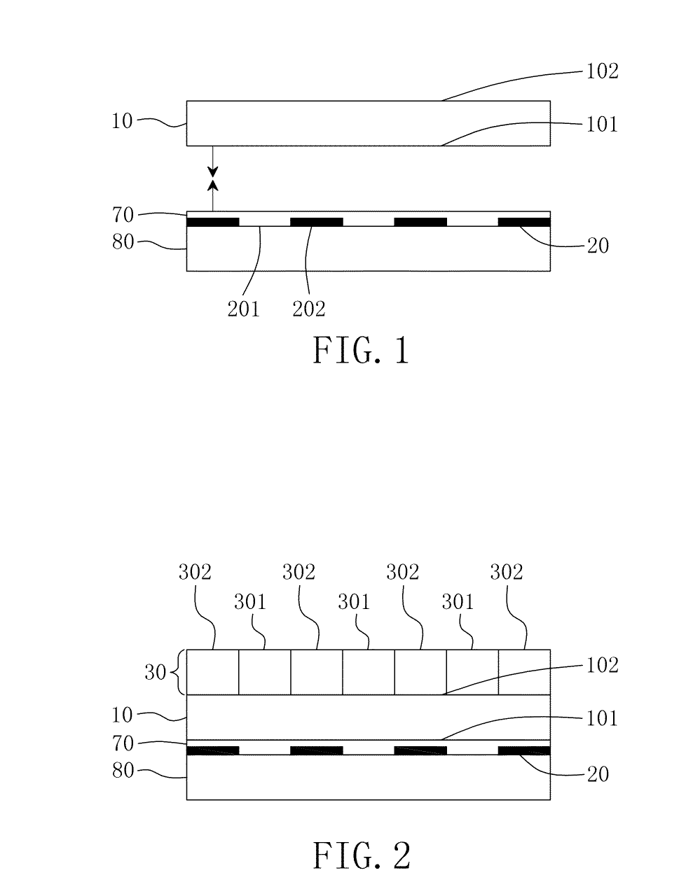

Referring to FIGS. 1 to 7, a first preferred embodiment of a method for fabricating a patterned retarder 52 according to the present invention includes the following steps (a) to (i).

In step (a), a first light-transmissive substrate 80 having opposite two surfaces is provided. One of the surfaces of the first light-transmissive substrate 80 includes a patterned photomask layer 20, and a pressure-sensitive adhesive layer 70 covering both of the patterned photomask layer 20 and the one of the surfaces of the first light-transmissive substrate 80. The patterned photomask layer 20 has a plurality of light-transmissive regions 201 in liner alignment, and a plurality of light-shielding regions 202 which alternate with the light-transmissive regions 201. The pressure-sensitive adhesive layer 70 is light-transmissive.

In step (b), a second light-transmissive substrate 10 having opposite front and rear surfaces 101, 102 is provided.

In step (c), the front surface 101 of the second light-transmissive substrate 10 is bonded to the pressure-sensitive adhesive layer 70 of the first light-transmissive substrate 80, such that the second light-transmissive substrate 10 is attached to the first light-transmissive substrate 80 (See FIG. 1).

In step (d), a photo-orientable layer 30 is formed on the rear surface 102 of the second light-transmissive substrate 10 (See FIG. 2).

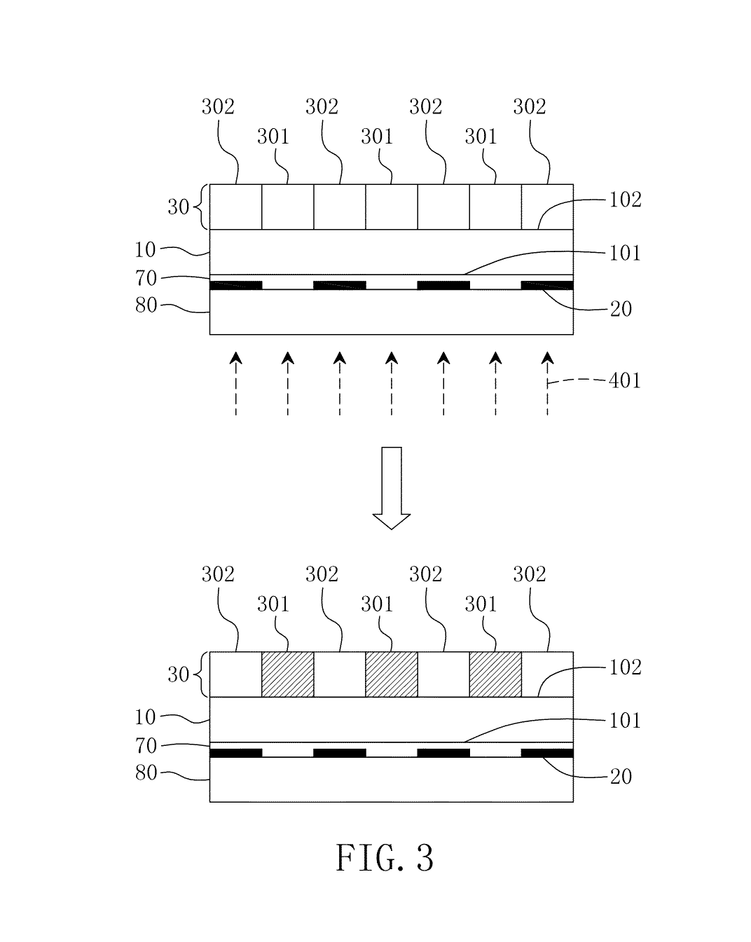

In step (e), the photo-orientable layer 30 is irradiated by first linearly-polarized ultraviolet light 401 through the first light-transmissive substrate 80 and the second light-transmissive substrate 10 in a direction from the front surface 101 toward the rear surface 102 of the second light-transmissive substrate 10 (from bottom to top in FIG. 3), such that a plurality of first regions 301 of the photo-orientable layer 30 are oriented in a first orientation direction by being irradiated with the first linearly-polarized ultraviolet light 401 that passed through the light-transmissive regions 201 of the patterned photomask layer 20 while leaving intact a plurality of second regions 302 of the photo-orientable layer 30, which are shielded by the light-shielding regions 202 of the patterned photomask layer 20 (See FIG. 3).

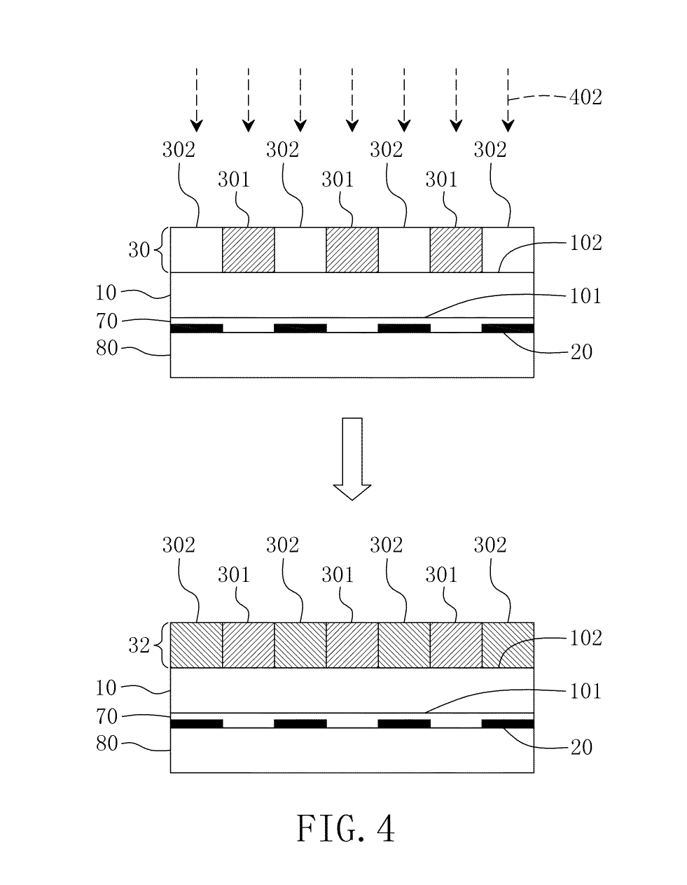

In step (f), the photo-orientable layer 30 is directly irradiated by second linearly-polarized ultraviolet light 402, which is different in polarizing direction from the first linearly-polarized ultraviolet light 401, in a direction from the rear surface 102 toward the front surface 101 of the second light-transmissive substrate 10 (from top to bottom in FIG. 4), such that the second regions 302 of the photo-orientable layer 30 are oriented in a second orientation direction different from the first orientation direction, so as to transform the photo-orientable layer 30 into a photo-alignment layer 32 which has the first and the second regions 301, 302 each having different orientation directions (See FIG. 4). The oriented first regions 301 are in register with the light-transmissive regions 201, respectively, and the oriented second regions 302 are in register with the light-shielding regions 202, respectively.

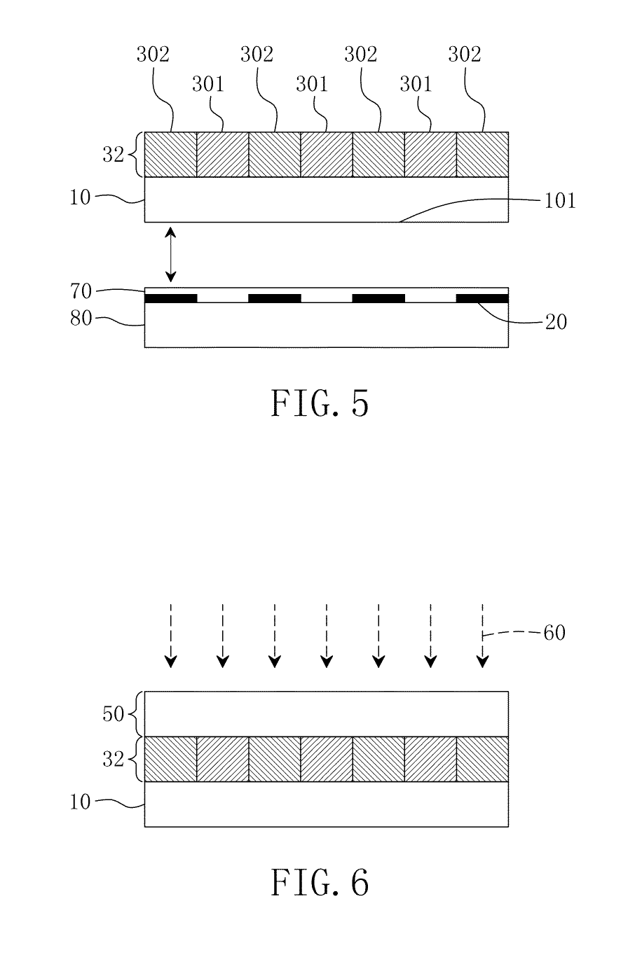

In step (i), the first light-transmissive substrate 80 is removed from the second light-transmissive substrate 10 by detaching the pressure-sensitive adhesive layer 70 from the front surface 101 of the second light-transmissive substrate 10 (See FIG. 5).

In step (g), a layer of liquid crystal material 50 is applied onto the photo-alignment layer 32 to permit a plurality of first liquid crystal regions 521 of the liquid crystal material layer 50 to be superimposed on and aligned by the oriented first regions 301, respectively, so as to be in a first state of orientation, and to permit a plurality of second liquid crystal regions 522 of the liquid crystal material layer 50 to be superimposed on and aligned by the oriented second regions 302, respectively, so as to be in a second state of orientation.

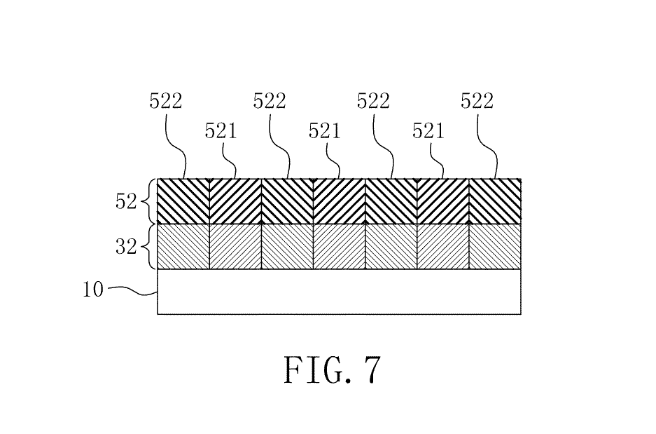

In step (h), the liquid crystal material layer 50 is cured, such that the liquid crystal material layer 50 is transformed into a patterned retarder 52 which has the first liquid crystal regions 521 and the second liquid crystal regions 522 each having different state of orientation (see FIGS. 6 and 7).

The steps described above are discussed in further detail below.

In this preferred embodiment, in step (a), the light-shielding regions 202 of the patterned photomask layer 20 can be formed on the first light-transmissive substrate 80 using conventional techniques, such as coating, deposition and printing techniques. In this embodiment, the light-shielding regions 202 are printed on one surface of the first light-transmissive substrate 80. The light-shielding regions 202 of the patterned photomask layer 20 are constituted by a material that is capable of absorbing or reflecting light of a particular range of wavelengths. In this embodiment, the material for the light-shielding regions 202 includes an ultraviolet radiation absorbing agent and a light-shielding ink.

The ultraviolet radiation absorbing agent may include, but is not limited to, benzophenone or benzotriazole.

The light-shielding ink may include, but is not limited to, carbon black, graphite, azo dye, or phthalocyanine.

The light-shielding regions 202 of the patterned photomask layer 20 may be printed by means of, for example, screen printing, gravure printing, and spraying.

Preferably, each of the light-shielding regions 202 has a light transmissibility less than 20%, more preferably less than 15%, and most preferably less than 10%, especially with respect to a specific wavelength range of light (e.g., ultraviolet light). The light transmissibility of each of the light-shielding regions 202 can be adjusted by controlling the concentrations of the ultraviolet radiation absorbing agent and the light-shielding ink. Herein, the light transmissibility of each light-shielding region 202 is defined as a ratio a luminous flux of light passing through the light-shielding region 202 to a luminous flux of light incident thereon.

Each of the first and the second light-transmissive substrates 80, 10 can be formed from any transparent flexible material, such as polyester-based resin, acetate-based resin, polyethersulfone-based resin, polycarbonate-based resin, polyamide-based resin, polyimide-based resin, polyolefin-based resin, acrylic-based resin, polyvinyl chloride-based resin, polystyrene-based resin, polyvinyl alcohol-based resin, polyarylate-based resin, polyphenylene sulfide-based resin, polyvinylidene chloride-based resin, or methacrylate-based resin.

Preferably, each of the first and the second light-transmissive substrates 80, 10 is formed from cellulose triacetate or polycarbonate.

In this preferred embodiment, in step (a), the pressure-sensitive adhesive layer 70 is formed to cover the first light-transmissive substrate 80 and the patterned photomask layer 20 so as to permit the first light-transmissive substrate 80 to be detachably attached to the front surface 101 of the second light-transmissive layer 10 through the pressure-sensitive adhesive layer 70 in step (c).

Preferably, the second light-transmissive substrate 10 is bonded to the first light-transmissive substrate 80 such that a slow axis of the second light-transmissive substrate 10 forms an angle of 0° or 90° to a slow axis of the first light-transmissive substrate 80.

The pressure-sensitive adhesive layer 70 can be formed by any conventional processes, such as spin coating, bar coating, or slot coating. In the process for forming the pressure-sensitive adhesive layer 70, a solution type pressure-sensitive adhesive material including a solvent is applied to cover the first light-transmissive substrate 80 and the patterned photomask layer 20 such that the first light-transmissive substrate 80 is slightly etched by the solvent. Thereafter, the solvent is removed. In this way, the bonding force between the pressure-sensitive adhesive layer 70 and the first light-transmissive substrate 80 can be enhanced, so that the pressure-sensitive adhesive layer 70 can still be bonded to the first light-transmissive substrate 80 when the first light-transmissive substrate 80 is removed from the second light-transmissive substrate 10 in step (i) (See FIG. 5).

In other preferred embodiments, the front surface 101 of the second light-transmissive substrate 10 can be treated by a releasing agent in advance in step (b), so as to reduce a bonding strength between the second light-transmissive substrate 10 and the pressure-sensitive adhesive layer 70 to permit the pressure-sensitive adhesive layer 70 to be releasably bonded to the treated front surface 101 of the second light-transmissive substrate 10 in step (c).

Examples of the material for the pressure-sensitive adhesive layer 70 include, but are not limited to, an acrylic pressure-sensitive adhesive, a polyurethane pressure-sensitive adhesive, a polyisobutylene pressure-sensitive adhesive, a rubber-based pressure-sensitive adhesive (such as styrene-butadiene rubber), a polyvinyl ether pressure-sensitive adhesive, an epoxy pressure-sensitive adhesive, a melamine pressure-sensitive adhesive, a polyester pressure-sensitive adhesive, a phenol pressure-sensitive adhesive, a silicon pressure-sensitive adhesive, or combinations thereof.

In this preferred embodiment, in step (d), the photo-orientable layer 30 can be formed by applying the photo-orientable material onto the rear surface 102 of the second light-transmissive substrate 10 using, for example, spin coating, bar coating, dip coating, slot coating, screen printing, or gravure printing.

Photo-orientable material for forming the photo-orientable layer 30 can be classified by their reaction mechanism into three different types: photo-induced isomerization material, photo-induced cross-linking material, and photo-induced decomposition material. Preferably, the photo-orientable material employed in the method of this invention is photo-induced cross-linking material.

Examples of the photo-induced cross-linking material include, but are not limited to, cinnamate derivatives, chalcone derivatives, maleimide derivatives, quinolinone derivatives, diphenylmethylene derivatives and coumarin derivatives.

In this preferred embodiment, in steps (e) and (f), preferably, the polarizing direction of the first linearly-polarized ultraviolet light 401 is perpendicular to the polarizing direction of the second linearly-polarized ultraviolet light 402.

As used herein, the term “linearly-polarized ultraviolet light” means plane-polarized ultraviolet light having a single linearly polarizing direction, and the linearly-polarized ultraviolet light is obtained by passing non-polarized ultraviolet light through a polarizer or an optical grid which permits light of only a predetermined polarizing direction to pass through.

As used herein, the term “non-polarized ultraviolet light” means circularly-polarized ultraviolet light that is emitted from a conventional ultraviolet light source, and that has a homogenous light intensity distribution in each direction.

When the photo-orientable layer 30 formed by a photo-induced cross-linking material in this embodiment is relatively exposed to the first and the second linearly-polarized ultraviolet light 401, 402, the molecules of the photo-induced cross-linking material can be activated to orientate in each specific orientation direction according to the polarizing directions of the first and the second linearly-polarized ultraviolet light 404, 402, and to undergo a cross-linking reaction so as to form a photo-alignment layer 32.

In order to ensure that the photo-orientable layer 30 has two different orientation directions after previously being irradiated by the first linearly-polarized ultraviolet light 401 and subsequently being irradiated by the second linearly-polarized ultraviolet light 402, the photo-orientable layer 30 is exposed to the first linearly-polarized ultraviolet light 401 in step (e) (see FIG. 3) at a first accumulated exposure dose and is exposed to the second linearly-polarized ultraviolet light 402 in step (f) (see FIG. 4) at a second accumulated exposure dose smaller than the first accumulated exposure dose. Because the second accumulated exposure dose is smaller than the first accumulated exposure dose, the oriented first regions 301 remain being oriented in the first orientation direction when exposed to the second linearly-polarized ultraviolet light 402 in step (f).

Since a higher accumulated exposure dose requires a longer exposure time, which will have an adverse effect on roll-to-roll processing and an increase in energy consumption and manufacturing costs, the first accumulated exposure dose is preferably not greater than 500 mJ/cm².

The second accumulated exposure dose is not limited, it depends on the operator's need (such as the restriction of irradiation equipment and the type of photo-orientable material used). As an example, the amount of the second accumulated exposure dose of the second linearly-polarized ultraviolet light 402 is preferably not less than 5 mJ/cm² when photo-induced cross-linking material is used.

As used herein, the term “accumulated exposure dose” means the total energy of light irradiated per unit area in a single irradiation.

In this preferred embodiment, in step (g), the liquid crystal material layer 50 is applied to the photo-alignment layer 32 by, for example, spin coating, bar coating, dip coating, slot coating, or roll-to-roll coating.

The liquid crystal material employed in this invention can be, but is not limited to, a photo-induced cross-linking type liquid crystal material.

When the liquid crystal material is applied to the photo-alignment layer 32, molecules of the liquid crystal material can be aligned respectively by the oriented first regions 301 and the oriented second regions 302 of the photo-alignment layer 32 to be in each predetermined state of orientation, thereby forming the first and the second liquid crystal regions 521, 522.

In this preferred embodiment, in step (h), the liquid crystal material layer 50 can be fully cured by being irradiated by non-polarized ultraviolet light 60 (see FIGS. 6 and 7).

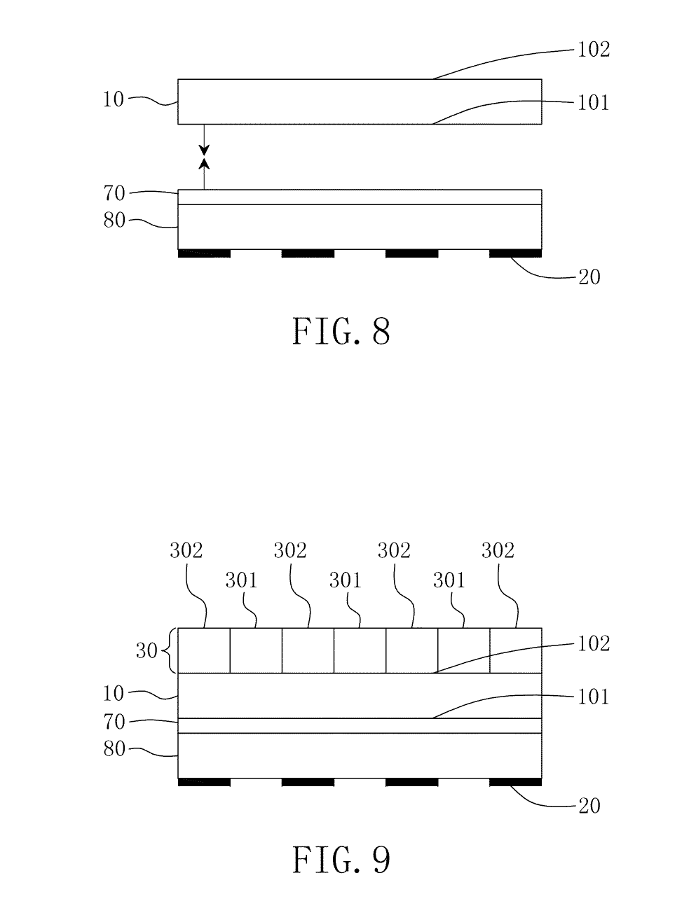

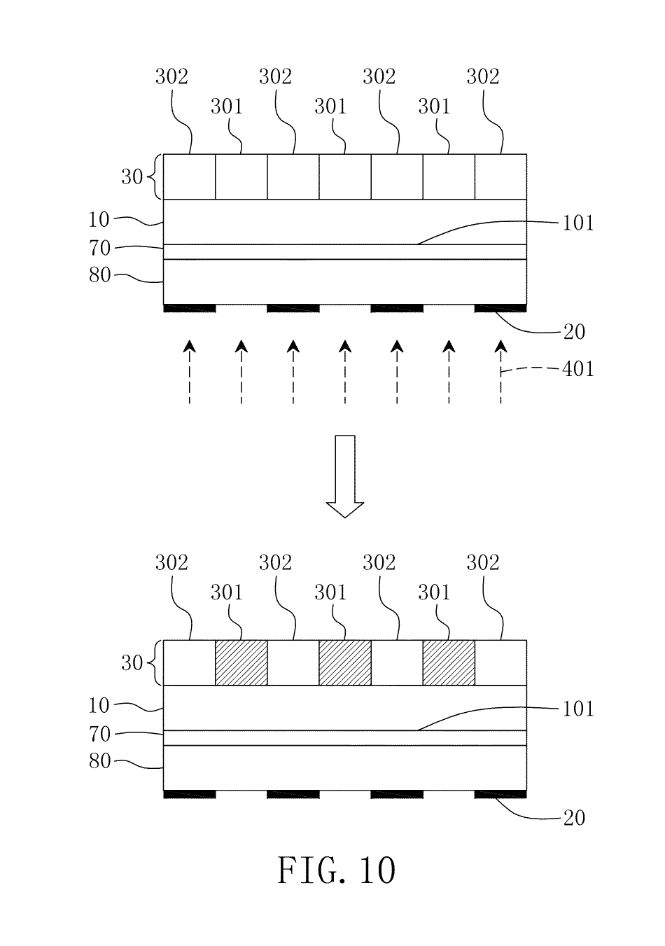

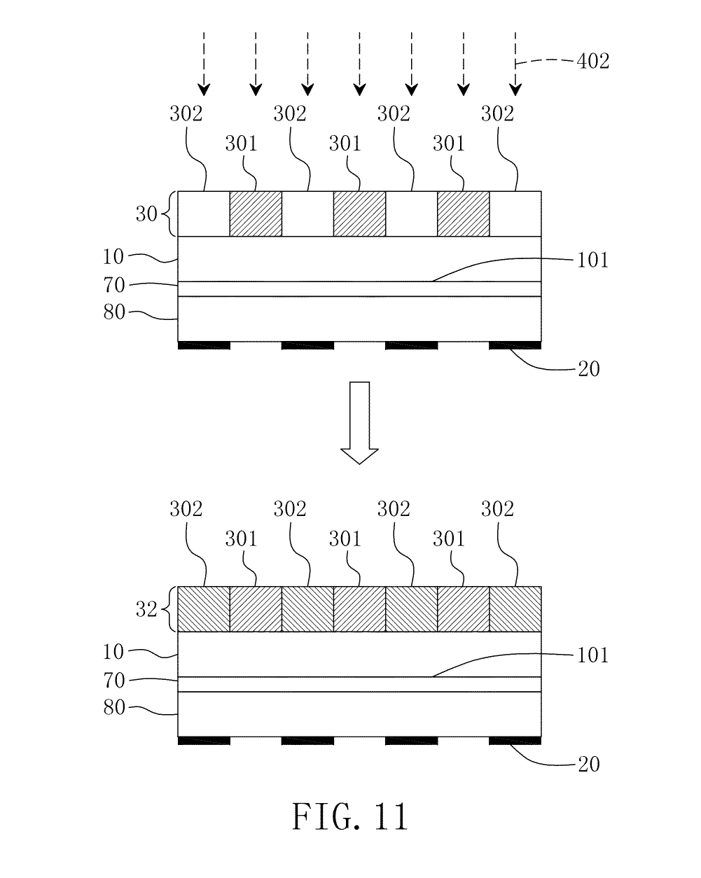

A second preferred embodiment of a method for fabricating a patterned retarder 52 according to this invention includes the aforesaid steps (a) to (i), and differs from the first preferred embodiment in the structure of the first light-transmissive substrate 80 (see FIGS. 8 to 12). In the first light-transmissive substrate 80 of this embodiment, the patterned photomask layer 20 is formed on one of the two opposite surfaces of the first light-transmissive substrate 80, and the pressure-sensitive adhesive layer 70 is formed on the other one of the two opposite surfaces of the second light-transmissive substrate 80.

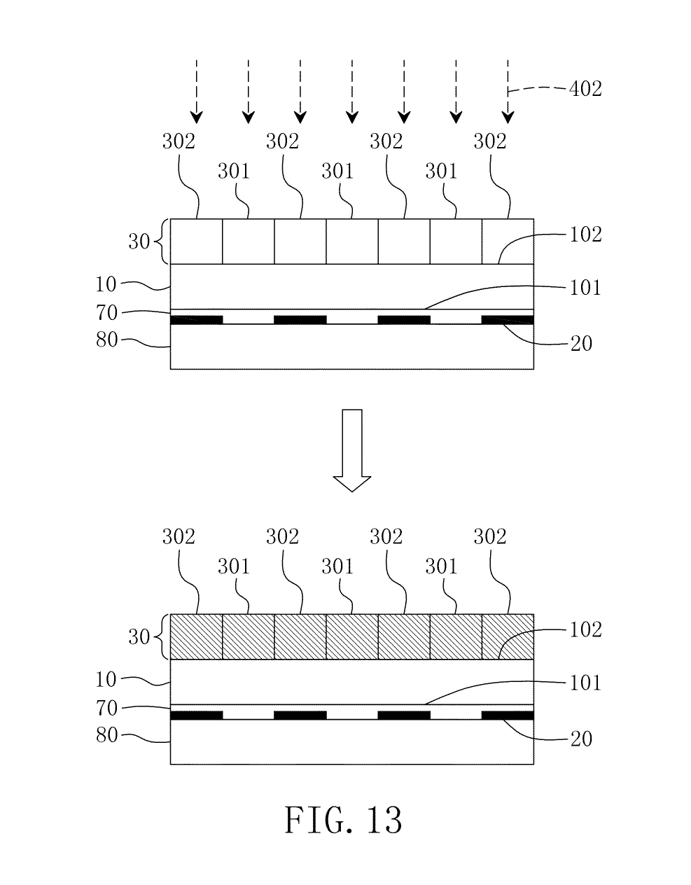

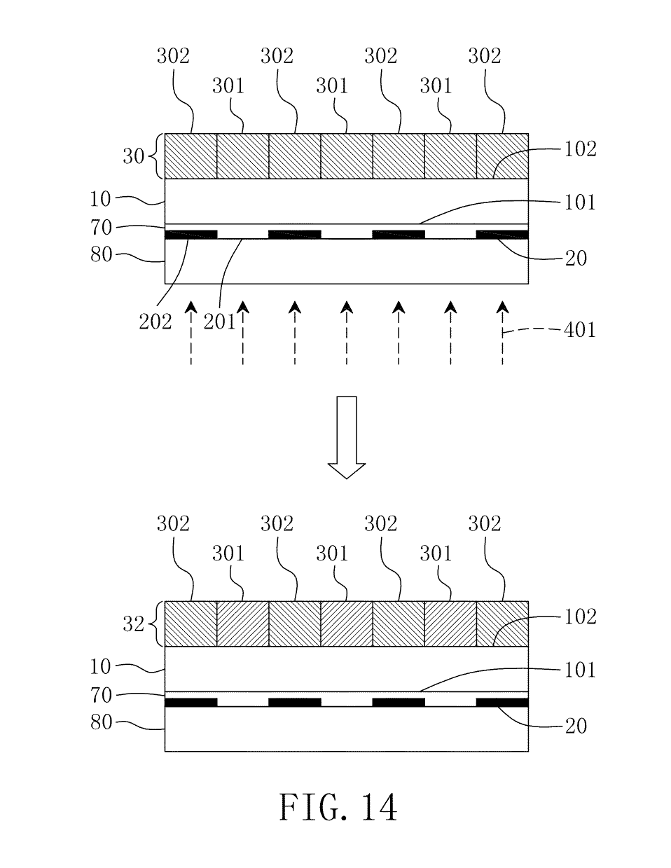

A third preferred embodiment of a method for fabricating a patterned retarder 52 according to this invention likewise includes steps (a) to (i). Steps (a) to (d) and (g) to (i) in the third preferred embodiment are substantially the same as those in the first preferred embodiment, but steps (e) and (f) are different (see FIGS. 13 and 14).

In this embodiment, step (e) is performed after step (f)

In step (f), the photo-orientable layer 30 is directly irradiated by the second linearly-polarized ultraviolet light 402 in a direction from the rear surface 102 toward the front surface 101 of the second light-transmissive substrate 10 (from top to bottom in FIG. 13), such that the whole regions of the photo-orientable layer 30 (i.e., the first regions 301 and the second regions 302) is oriented in the second orientation direction by being irradiated with the second linearly-polarized ultraviolet light 402 (See FIG. 13).

In step (e), the photo-orientable layer 30 is irradiated by the first linearly-polarized ultraviolet light 401, which is different in polarizing direction from the second linearly-polarized ultraviolet light 402, through the first light-transmissive substrate 80 and the second light-transmissive substrate 10 in a direction from the front surface 101 toward the rear surface 102 of the second light-transmissive substrate 10 (from bottom to top in FIG. 14), such that the first regions 301 of the photo-orientable layer 30 is oriented in a first orientation direction by being irradiated with the first linearly-polarized ultraviolet light 401 that passed through the light-transmissive regions 201 of the patterned photomask layer 20 while leaving intact the second regions 302 of the photo-orientable layer 30, which are oriented in the second orientation direction in step (f) previously, and which are shielded by the light-shielding regions 202 of the patterned photomask layer 20, thereby transforming the photo-orientable layer 30 into a photo-alignment layer 32 having two different orientation directions (i.e., the first and the second orientation directions) (see FIG. 14). The oriented first regions 301 are in register with the light-transmissive regions 201, respectively, and the oriented second regions 302 are in register with the light-shielding regions 202, respectively.

In the third preferred embodiment, in order to ensure that the photo-orientable layer 30 has two different orientation directions after previously being irradiated by the second linearly-polarized ultraviolet light 402 and subsequently being irradiated by the first linearly-polarized ultraviolet light 401, the photo-orientable layer 30 is exposed to the first linearly-polarized ultraviolet light 401 in step (e) (see FIG. 14) at a first accumulated exposure dose and is exposed to the second linearly-polarized ultraviolet light 402 in step (f) (see FIG. 13) at a second accumulated exposure dose not greater than the first accumulated exposure dose. Because the second accumulated exposure dose is not greater than the first accumulated exposure dose, the orientation direction of the first regions 301 can be converted by being irradiated by the first linearly-polarized ultraviolet light 401, such that the first regions 301 are oriented in the first orientation direction in step (e).

Similarly to the first preferred embodiment, the first accumulated exposure dose is preferably not greater than 500 mJ/cm².

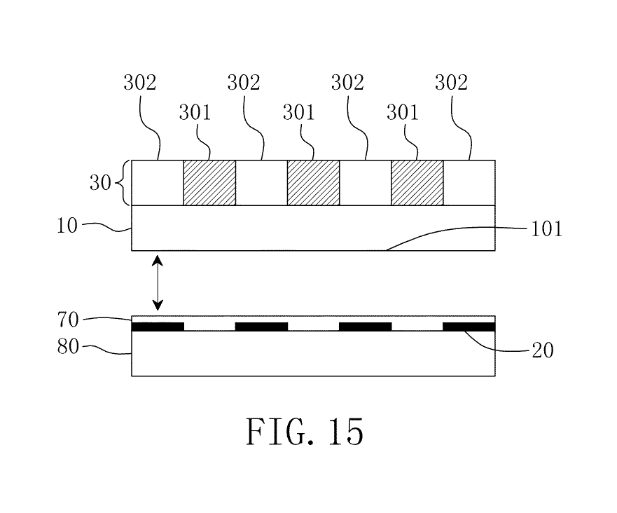

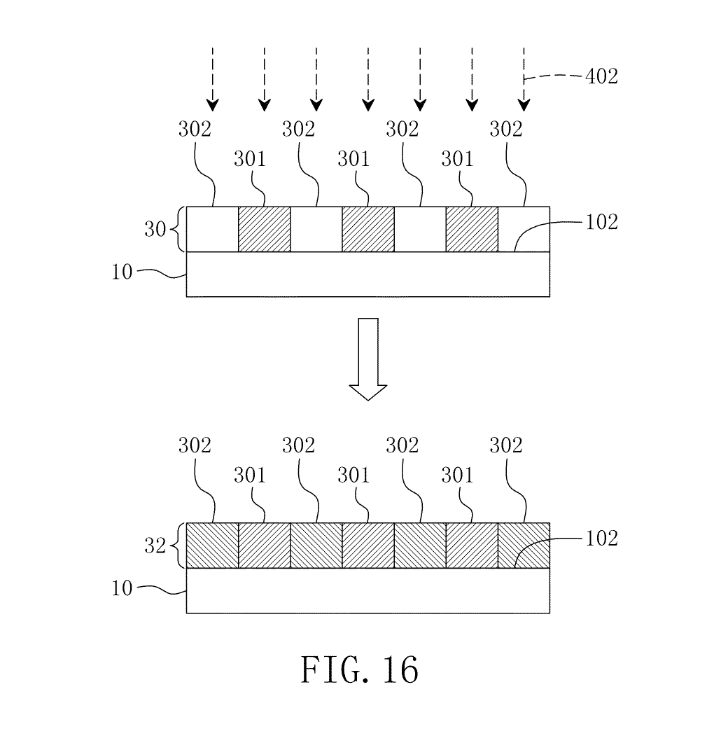

A fourth preferred embodiment of a method for fabricating a patterned retarder 52 according to this invention likewise includes steps (a) to (i). Steps (a) to (e) and (g) to (h) in the fourth preferred embodiment are substantially the same as those in the first preferred embodiment, but steps (i) and (f) are different (See FIGS. 15 and 16).

In this fourth embodiment, step (i) is performed between step (e) and step (f), that is, the first light-transmissive substrate 80 is removed from the second light-transmissive substrate 10 before the photo-orientable layer 30 is irradiated by the second linearly-polarized ultraviolet light 402.

In a fifth preferred embodiment of this invention, a method for fabricating a patterned retarder 52 includes the following steps (I) to (IX).

In step (I), a second light-transmissive substrate 10 having opposite front and rear surfaces 101, 102 is provided. This step is substantially the same as step (b) in the first preferred embodiment.

In step (II), a photo-orientable layer 30 is formed on the rear surface 102 of the second light-transmissive substrate 10.

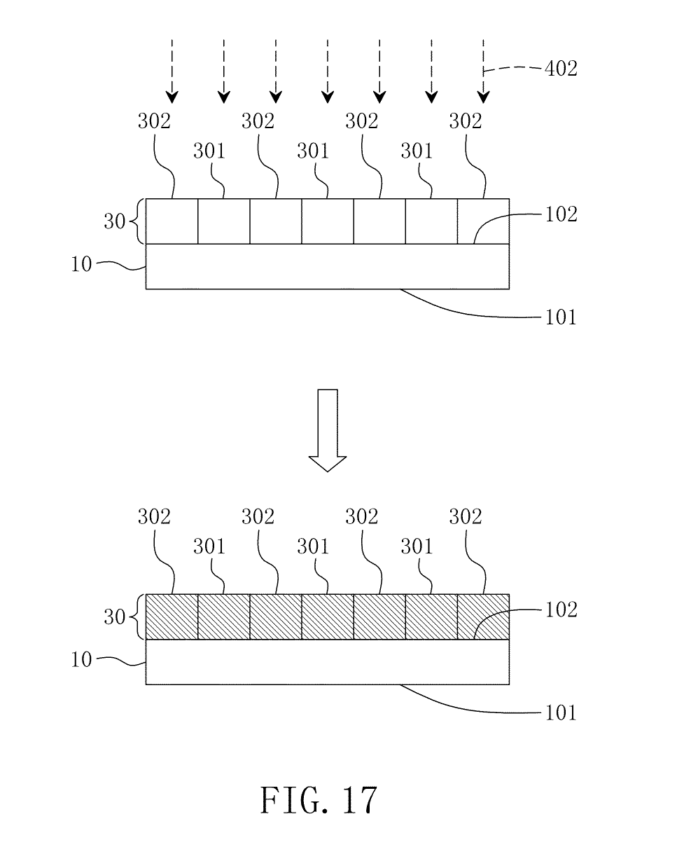

In step (III), the photo-orientable layer 30 is directly irradiated by the second linearly-polarized ultraviolet light 402 in a direction from the rear surface 102 toward the front surface 101 of the second light-transmissive substrate 10 (from top to bottom in FIG. 17), such that the whole regions of the photo-orientable layer 30 (i.e., the first regions 301 and the second regions 302) is oriented in the second orientation direction by being irradiated with the second linearly-polarized ultraviolet light 402 (See FIG. 17).

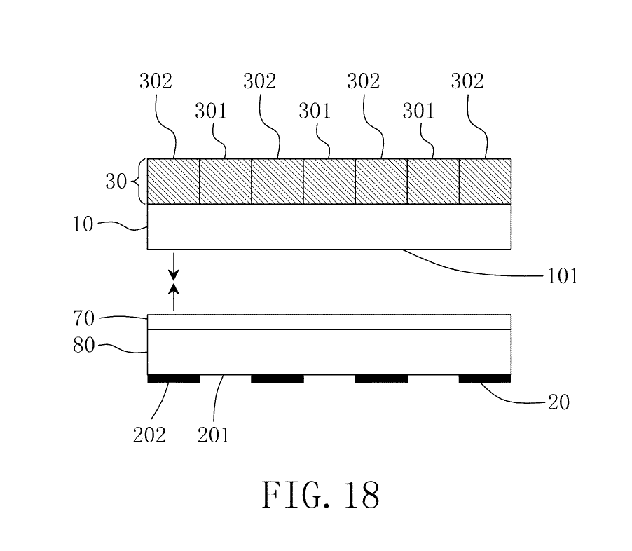

In step (IV), a first light-transmissive substrate 80 having opposite two surfaces is provided. One of the two opposite surfaces of the first light-transmissive substrate 80 includes a patterned photomask layer 20, and the other one of the two opposite surfaces of the first light-transmissive substrate 80 includes a pressure-sensitive adhesive layer 70 covering the other one of the surfaces of the first light-transmissive substrate 80. The patterned photomask layer 20 has a plurality of light-transmissive regions 201 in liner alignment, and a plurality of light-shielding regions 202 which alternate with the light-transmissive regions 201. The pressure-sensitive adhesive layer 70 is light-transmissive (See FIG. 18).

In step (V), the front surface 101 of the second light-transmissive substrate 10 is bonded to the pressure-sensitive adhesive layer 70 of the first light-transmissive substrate 80, such that the second light-transmissive substrate 10 is attached to the first light-transmissive substrate 80 (See FIG. 18).

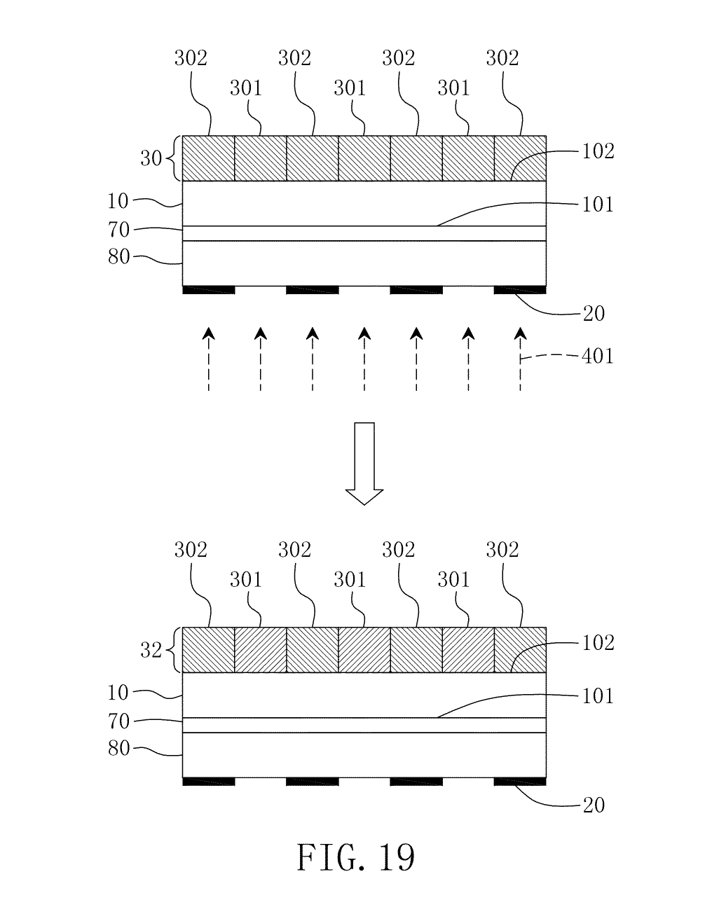

In step (VI), the photo-orientable layer 30 is irradiated by the first linearly-polarized ultraviolet light 401, which is different in polarizing direction from the second linearly-polarized ultraviolet light 402, through the first light-transmissive substrate 80 and the second light-transmissive substrate 10 in a direction from the front surface 101 toward the rear surface 102 of the second light-transmissive substrate 10 (from bottom to top in FIG. 19), such that the first regions 301 of the photo-orientable layer 30 is oriented in a first orientation direction by being irradiated with the first linearly-polarized ultraviolet light 401 that passed through the light-transmissive regions 201 of the patterned photomask layer 20 while leaving intact the second regions 302 of the photo-orientable layer 30, which are oriented in the second orientation direction in step (III) previously, and which are shielded by the light-shielding regions 202 of the patterned photomask layer 20, thereby transforming the photo-orientable layer 30 into a photo-alignment layer 32 having two different orientation directions (see FIG. 19). The oriented first regions 301 are in register with the light-transmissive regions 201, respectively, and the oriented second regions 302 are in register with the light-shielding regions 202, respectively.

In the fifth preferred embodiment, similar to the third preferred embodiment, in order to ensure that the photo-orientable layer 30 has two different orientation directions after previously being irradiated by the second linearly-polarized ultraviolet light 402 and subsequently being irradiated by the first linearly-polarized ultraviolet light 401, the photo-orientable layer 30 is exposed to the first linearly-polarized ultraviolet light 401 in step (VI) (See FIG. 19) at a first accumulated exposure dose and is exposed to the second linearly-polarized ultraviolet light 402 in step (III) (See FIG. 17) at a second accumulated exposure dose not greater than the first accumulated exposure dose.

Similarly to the first preferred embodiment, the first accumulated exposure dose is preferably not greater than 500 mJ/cm².

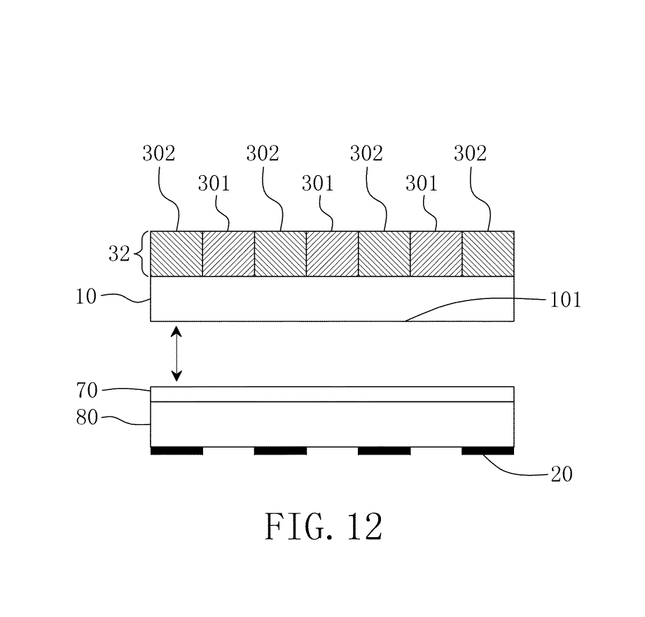

In step (VII), the first light-transmissive substrate 80 is removed from the second light-transmissive substrate 10 by detaching the pressure-sensitive adhesive layer 70 from the front surface 101 of the second light-transmissive substrate 10 (See also FIG. 12).

In step (VIII), a layer of liquid crystal material 50 is applied onto the photo-alignment layer 32 to permit a plurality of first liquid crystal regions 521 of the liquid crystal material layer 50 to be superimposed on and aligned by the oriented first regions 301, respectively, so as to be in a first state of orientation, and to permit a plurality of second liquid crystal regions 522 of the liquid crystal material layer 50 to be superimposed on and aligned by the oriented second regions 302, respectively, so as to be in a second state of orientation. This step is substantially the same as step (g) in the first preferred embodiment.

In step (IX), the liquid crystal material layer 50 is cured, such that the liquid crystal material layer 50 is transformed into a patterned retarder 52 which has the first liquid crystal regions 521 and the second liquid crystal regions 522 each having different state of orientation (See also FIGS. 6 and 7). This step is substantially the same as step (h) in the first preferred embodiment.

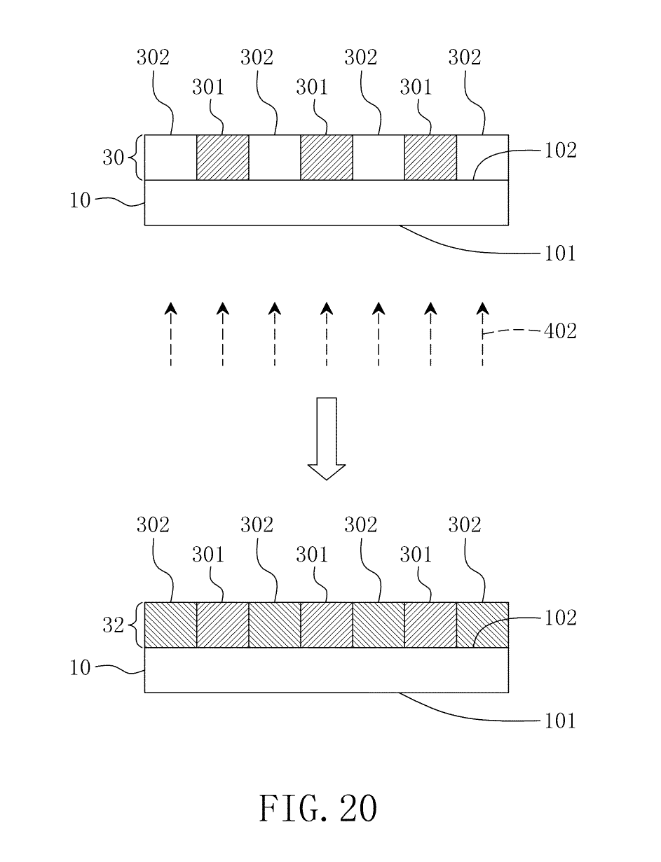

A sixth preferred embodiment of a method for fabricating a patterned retarder 52 according to this invention is substantially similar to the fourth preferred embodiment, but the irradiating direction of the second linearly-polarized ultraviolet light 402 in step (f) is different (See FIG. 20).

In this embodiment, in step (f), the photo-orientable layer 30 is irradiated by second linearly-polarized ultraviolet light 402 which is different in polarizing direction from the first linearly-polarized ultraviolet light 401, through the second light-transmissive substrate 10 in a direction from the front surface 101 toward the rear surface 102 of the second light-transmissive substrate 10 (from bottom to top in FIG. 20), such that the second regions 302 of the photo-orientable layer 30 are oriented in a second orientation direction different from the first orientation direction, so as to transform the photo-orientable layer 30 into a photo-alignment layer 32 which has the first and the second regions 301, 302 each having different orientation directions (See FIG. 20).

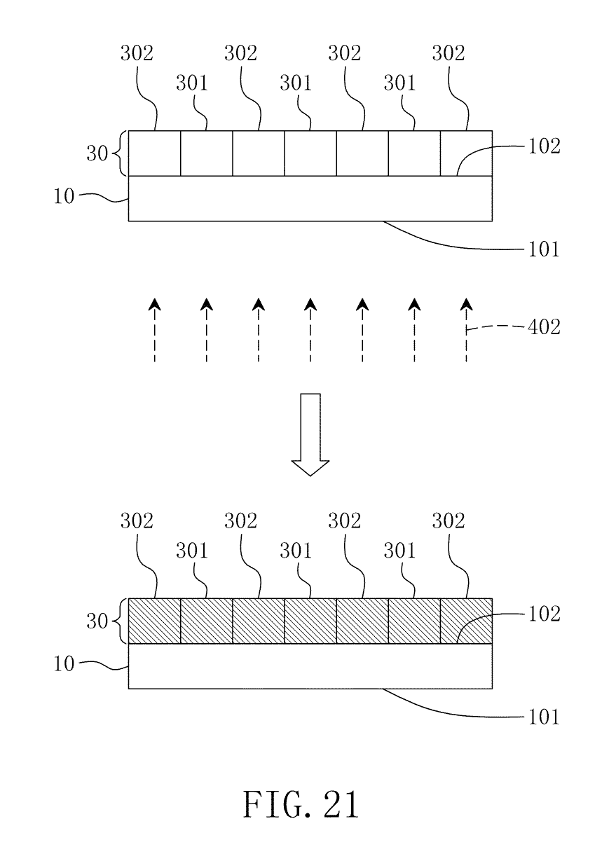

A seventh preferred embodiment of a method for fabricating a patterned retarder 52 according to this invention is substantially similar to the fifth preferred embodiment, but the irradiating direction of the second linearly-polarized ultraviolet light 402 in step (III) is different (see FIG. 21).

In this embodiment, in step (III), the photo-orientable layer 30 is irradiated by second linearly-polarized ultraviolet light 402 through the second light-transmissive substrate 10 in a direction from the front surface 101 toward the rear surface 102 of the second light-transmissive substrate 10 (from bottom to top in FIG. 21), such that the whole regions of the photo-orientable layer 30 (i.e., the first regions 301 and the second regions 302) are oriented in the second orientation direction by being irradiated with the second linearly-polarized ultraviolet light 402 (See FIG. 21).

In each of the preferred embodiments described herein, the first and the second light-transmissive substrates 80, 10 respectively have first and second retardation values. The retardation value (R₀) of each of the substrates is a product of birefringence (Δn) and a thickness (d) of each of the substrates.

If the sum of the first and the second retardation values is too high, the linearly-polarized ultraviolet light passing through the first and the second light-transmissive substrates 80, 10 may be converted to circularly-polarized ultraviolet light or elliptically polarized ultraviolet light. In this case, the first and the second regions 301, 302 of the photo-alignment layer 32 may not be oriented in different directions, and the molecules of the liquid crystal material layer 50 applied onto two different predetermined regions (i.e., the first and the second regions 301, 302) may not be aligned in two different predetermined states of orientation.

In each of the preferred embodiments described herein, when the slow axis of the second light-transmissive substrate 10 forms an angle of 0° or 90° with respect to a polarizing direction of one of the first linearly-polarized ultraviolet light 401 and the second linearly-polarized ultraviolet light 402, a sum of the first and the second retardation values is preferably less than 300 nm. When the slow axis of the second light-transmissive substrate 10 forms an angle of 45° with respect to the polarizing direction of one of the first linearly-polarized ultraviolet light 401 and the second linearly-polarized ultraviolet light 402, a sum of the first and the second retardation values is less than 100 nm.

The present invention will now be explained in more detail below by way of the following examples and comparative examples.

### Example A1 (EX A1)

A patterned retarder of Example A1 was prepared by the following sequential steps.

(1) Preparation of a Photo-Orientable Material

(1a) 1.75 g of methylethylketone and 1.75 g of cyclopentanone were mixed to form a solvent mixture.

(1b) 0.5 g of a cinnamate resin (a photo-induced cross-linking type photo-orientable material, available from Swiss Rolic Co., trade name: ROP103, having a solid content of 10%) was dissolved in the solvent mixture to obtain a photo-orientable slurry (S1) with a solid content of 1.25%.

(2) Preparation of a Liquid Crystal Material

1 g of a liquid crystal (available from BASF, trade name: LC242) was added to 4 g of cyclopentanone to obtain a liquid crystal material (S2) with a solid content of 20%.

(3) Preparation of a Patterned Photomask Layer

(3a) 5 g of a binder (a thermosetting resin) and 5 g of toluene were mixed to form a binder solution.

(3b) 0.2 g of an ultraviolet absorbing agent (available from Everlight Chem. Co., trade name: Eversorb51) was added into the binder solution to form an ink material (the weight ratio of the ultraviolet absorbing agent to the binder was 1:25). The ink material was applied using a gravure printing technique to a surface of a polycarbonate substrate (i.e., the first light-transmissive substrate) to form a predetermined pattern with a printed thickness of 1 μm thereon. The polycarbonate substrate had a size of 10 cm×10 cm, a thickness of 30 μm, a birefringence (Δn) of 2.17×10⁻⁴ and a retardation value (R₀) of 6.5 nm. Then the polycarbonate substrate with the predetermined pattern was baked in an oven at 60° C. for 30 seconds so as to form a patterned photomask layer with a plurality of light-transmissive regions and a plurality of light-shielding regions. The light-shielding regions on the polycarbonate substrate had a light transmissibility of 10%.

(4) Preparation of a Pressure-Sensitive Adhesive Layer

10 g of acrylic acid-based pressure sensitive adhesive material (having a solid content of 40%, in which a volume ratio of ethyl acetate to methylethylketone was 8:2), was applied to the surface of the polycarbonate substrate, which was formed with the predetermined patterned photomask layer, to fully cover the patterned photomask layer on the polycarbonate substrate using a bar coating technique, followed by baking in an oven at 100° C. for 2 minutes to remove the solvent. Thereafter, the polycarbonate substrate formed with the patterned photomask layer and the coated layer was allowed to cool to room temperature so as to form a pressure-sensitive adhesive layer on the polycarbonate substrate. The pressure-sensitive adhesive layer had a thickness of 20 μm, and a peel strength (against glass) of 200 gf/25 mm.

(5) Preparation of a Patterned Retarder

(5a) Adhesion of the Pressure-Sensitive Adhesive Layer to Second Light-Transmissive Substrate

The pressure-sensitive adhesive layer was bonded to a front surface of another polycarbonate substrate (i.e., the second light-transmissive substrate 10, having a size of 10 cm×10 cm, a thickness of 30 μm, a birefringence (Δn) of 2.17×10⁻⁴ and a retardation value (R₀) of 6.5 nm, such that the first and the second light-transmissive substrates were bonded to one another. A slow axis of the first light-transmissive substrate formed an angle of 0° with respect to a slow axis of the second light-transmissive substrate (See FIG. 1).

(5b) Preparation of a Photo-Orientable Layer

4 g of the photo-orientable slurry (S1) was applied evenly to a rear surface of the second light-transmissive substrate opposite to the first light-transmissive substrate using a spin coating technique (speed: 3000 rpm for 40 seconds), followed by baking in an oven at 100° C. for two minutes to remove the solvents (i.e., methylethylketone and cyclopentanone) in the photo-orientable slurry (S1), and cooling to room temperature so as to form a photo-orientable layer with a thickness of 50 nm.

(5c) First Irradiation Using First Linearly-Polarized Ultraviolet Light

The photo-orientable layer was exposed to first linearly-polarized ultraviolet light through the light-transmissive regions of the patterned photomask layer at a first accumulated exposure dose of 180 mJ/cm² (See also FIG. 3). The slow axis of the second light-transmissive substrate formed an angle of 0° with respect to a polarizing direction of the first linearly-polarized ultraviolet light. The first linearly-polarized ultraviolet light was uncollimated light. In this step, a plurality of first regions of the photo-orientable layer were exposed to the first linearly-polarized ultraviolet light which passed through the light-transmissive regions of the patterned photomask layer, and were oriented in a first orientation direction.

(5d) Removal of the First Light-Transmissive Substrate The first light-transmissive substrate was removed from the second light-transmissive substrate by detaching the pressure-sensitive adhesive layer from the front surface of the second light-transmissive substrate (See also FIG. 15).

(5e) Second Irradiation Using Second Linearly-Polarized Ultraviolet Light

The photo-orientable layer was exposed to second linearly-polarized ultraviolet light through the second light-transmissive substrate at a second accumulated exposure dose of 90 mJ/cm², such that a plurality of second regions of the photo-orientable layer, which were shielded by the light-shielding regions of the patterned photomask layer in the step (5c), were oriented in a second orientation direction different from the first orientation direction, while the first orientation direction of the first regions was left unaltered, thereby transforming the photo-orientable layer into a photo-alignment layer which had two different orientation directions (i.e., the first and the second orientation directions) (See also FIG. 20). The slow axis of the second light-transmissive substrate formed an angle of 90° with respect to a polarizing direction of the second linearly-polarized ultraviolet light. The second linearly-polarized ultraviolet light was uncollimated light. In this step, a plurality of second regions of the photo-orientable layer and the first regions of the photo-orientable layer were exposed to the second linearly-polarized ultraviolet light simultaneously, thereby transforming the photo-orientable layer into a photo-alignment layer which had two different orientation directions (i.e., the first and the second orientation directions).

(5f) Preparation of a Patterned Retarder

5 g of the liquid crystal material (S2) was applied to the first and the second regions of the photo-alignment layer using a spin coating technique (speed: 3000 rpm for 40 seconds), followed by baking in an oven at 60° C. for 5 minutes to remove the solvent (i.e., cyclopentanone) and cooling to room temperature so as to form the liquid crystal material layer.

(5 g) Curing of the Liquid Crystal Material Layer

The liquid crystal material layer was cured by non-linear polarized ultraviolet light at an accumulated exposure dose of 120 mJ/cm², thereby transforming the liquid crystal material layer into a patterned retarder (See also FIGS. 6 and 7).

### Example A2 (EX A2)

A patterned retarder of Example A2 was made according to the process employed in Example A1, except that each of the first and the second light-transmissive substrates had a birefringence (Δn) of 4.50×10⁻³ and a retardation value (R₀) of 135 nm.

### Example A3 (EX A3)

A patterned retarder of Example A3 was made according to the process employed in Example A1, except that each of the first and the second light-transmissive substrates had a birefringence (Δn) of 1.33×10⁻³ and a retardation value (R₀) of 40 nm.

### Example A4 (EX A4)

A patterned retarder of Example A4 was made according to the process employed in Example A3, except that the polarizing direction of the first linearly-polarized ultraviolet light formed an angle of +45° with respect to the slow axis of the second light-transmissive substrate, and that the polarizing direction of the second linearly-polarized ultraviolet light formed an angle of −45° with respect to the slow axis of the second light-transmissive substrate.

### Comparative Example A1 (CE A1)

A patterned retarder of Comparative Example A1 was made according to the process employed in Example A1, except that each of the first and the second light-transmissive substrates had a birefringence (Δn) of 5.00×10⁻³ and a retardation value (R₀) of 150 nm.

### Comparative Example A2 (CE A2)

A patterned retarder of Comparative Example A2 was made according to the process employed in Example A4, except that each of the first and the second light-transmissive substrates had a birefringence (Δn) of 1.67×10⁻³ and a retardation value (R₀) of 50 nm.

### Example A5 (EX A5)

A patterned retarder of Example A5 was made according to the process employed in Example A1, except that, in step (4), the pressure sensitive adhesive material was applied to a surface of the polycarbonate substrate (i.e., the first light-transmissive substrate 80) that is opposite to the patterned photomask layer. In addition, in Example A5, steps (5a) to (5e) were replaced by the following steps (5A) to (5E).

(5A) Preparation of a Photo-Orientable Layer

This step was similar to step (5b) of Example A1, except that the first and the second light-transmissive substrates were not bonded yet.

(5B) First Irradiation Using Second Linearly-Polarized Ultraviolet Light

The photo-orientable layer was exposed to second linearly-polarized ultraviolet light through the second light-transmissive substrate at a second accumulated exposure dose of 90 mJ/cm². The slow axis of the second light-transmissive substrate formed an angle of 90° with respect to a polarizing direction of the second linearly-polarized ultraviolet light. The second linearly-polarized ultraviolet light was uncollimated light. In this step, pluralities of first and second regions of the photo-orientable layer were exposed to the second linearly-polarized ultraviolet light simultaneously, and were oriented in a second oriented direction (See FIG. 21).

(5C) Adhesion of the Pressure-Sensitive Adhesive Layer to Second Light-Transmissive Substrate

This step was similar to step (5a) of Example A1, except that, after the first and the second light-transmissive substrates were bonded to one another, the patterned photomask layer was disposed on the surface of the first light-transmissive substrate, which was opposite to the second light-transmissive substrate as shown in FIGS. 18 and 19.

(5D) Second Irradiation Using First Linearly-Polarized Ultraviolet Light

The photo-orientable layer was exposed to first linearly-polarized ultraviolet light through the light-transmissive regions of the patterned photomask layer at a first accumulated exposure dose of 90 mJ/cm². The slow axis of the second light-transmissive substrate formed an angle of 0° with respect to a polarizing direction of the first linearly-polarized ultraviolet light. The first linearly-polarized ultraviolet light was uncollimated light. In this step, the first regions of the photo-orientable layer were exposed to the first linearly-polarized ultraviolet light which passed through the light-transmissive regions of the patterned photomask layer, and were oriented in a first orientation direction which was different from the second orientation direction, thereby transforming the photo-orientable layer into a photo-alignment layer which had two different orientation directions (i.e., the first and the second orientation directions) (See FIG. 19).

(5E) Removal of the First Light-Transmissive Substrate

The first light-transmissive substrate was removed from the second light-transmissive substrate by detaching the pressure-sensitive adhesive layer from the front surface of the second light-transmissive substrate (See FIG. 12).

### Example A6 (EX A6)

A patterned retarder of Example A6 was made according to the process employed in Example A5, except that each of the first and the second light-transmissive substrates had a birefringence (Δn) of 4.50×10⁻³ and a retardation value (R₀) of 135 nm.

### Example A7 (EX A7)

A patterned retarder of Example A7 was made according to the process employed in Example A5, except that each of the first and the second light-transmissive substrates had a birefringence (Δn) of 1.33×10⁻³ and a retardation value (R₀) of 40 nm.

### Example A8 (EX A8)

A patterned retarder of Example A8 was made according to the process employed in Example A7, except that the polarizing direction of the second linearly-polarized ultraviolet light formed an angle of −45° with respect to the slow axis of the second light-transmissive substrate, and that the polarizing direction of the first linearly-polarized ultraviolet light formed an angle of +45° with respect to the slow axis of the second light-transmissive substrate.

### Comparative Example A3 (CE A3)

A patterned retarder of Comparative Example A3 was made according to the process employed in Example A5, except that each of the first and the second light-transmissive substrates had a birefringence (Δn) of 5.00×10⁻³ and a retardation value (R₀) of 150 nm.

### Comparative Example A4 (CE A4)

A patterned retarder of Comparative Example A4 was made according to the process employed in Example A8, except that each of the first and the second light-transmissive substrates had a birefringence (Δn) of 1.67×10⁻³ and a retardation value (R₀) of 50 nm.

The orientation state of each of the patterned retarders of Examples A1 to A8 and Comparative Examples A1 to A4 was analyzed using a birefringence analyzer (manufactured by Oji Scientific Instruments, trade name: KOBRA-CCD). The measured results are shown in Table 1.

TABLE 1

| | Sum of | Angle | |
|---|---|---|---|
| | retardation | between A1 | Number of |
| | values*¹ (nm) | and A2*² | orientation states |
| EX A1 | 13 | 0° | 2 |
| EX A2 | 270 | 0° | 2 |
| EX A3 | 80 | 0° | 2 |
| EX A4 | 80 | +45° | 2 |
| EX A5 | 13 | 0° | 2 |
| EX A6 | 270 | 0° | 2 |
| EX A7 | 80 | 0° | 2 |
| EX A8 | 80 | +45° | 2 |
| CE A1 | 300 | 0° | 1*³ |
| CE A2 | 100 | +45° | 1 |
| CE A3 | 300 | 0° | 1 |
| CE A4 | 100 | +45° | 1 |

*¹Sum of a first retardation value of the first light-transmissive substrate and a second retardation value of the second light-transmissive substrate.
*²A1 represents the polarizing direction of the first linearly-polarized ultraviolet light, and A2 represents the slow axis of the second light-transmissive substrate.
*³Only either the first regions or the second regions had an orientation state.

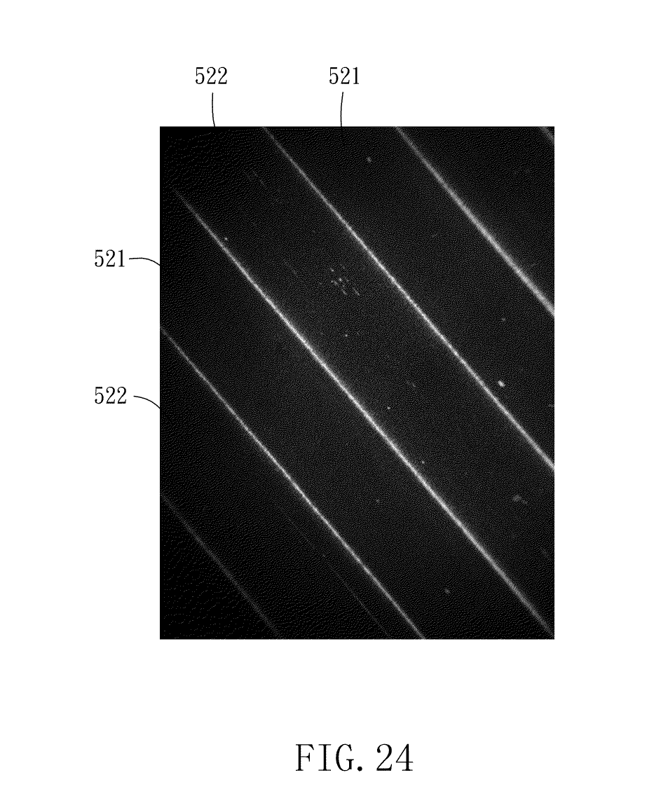

From the results of Example A1 to A3 and A5 to A7 shown in Table 1, it was found that when the slow axis of the second light-transmissive substrate formed an angle of 0° with respect to the polarizing direction of the first linearly-polarized ultraviolet light, and when the sum of a first retardation value of the first light-transmissive substrate and a second retardation value of the second light-transmissive substrate was less than 300 nm, the liquid crystal molecules of the liquid crystal material layer could be aligned in two different states of orientation. This means that the photo-alignment layer in each of those examples had two oriented regions that were respectively oriented in two different directions. Referring to FIG. 24 which shows a polarized microscope image of the patterned retarder of Example A1, it was found that there is a clear boundary between the regions that were oriented in two different directions.

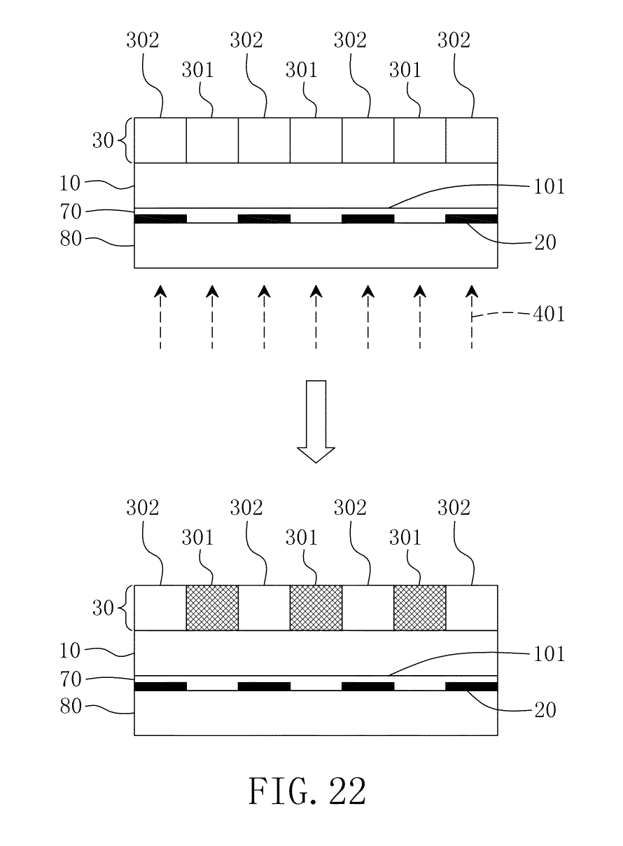

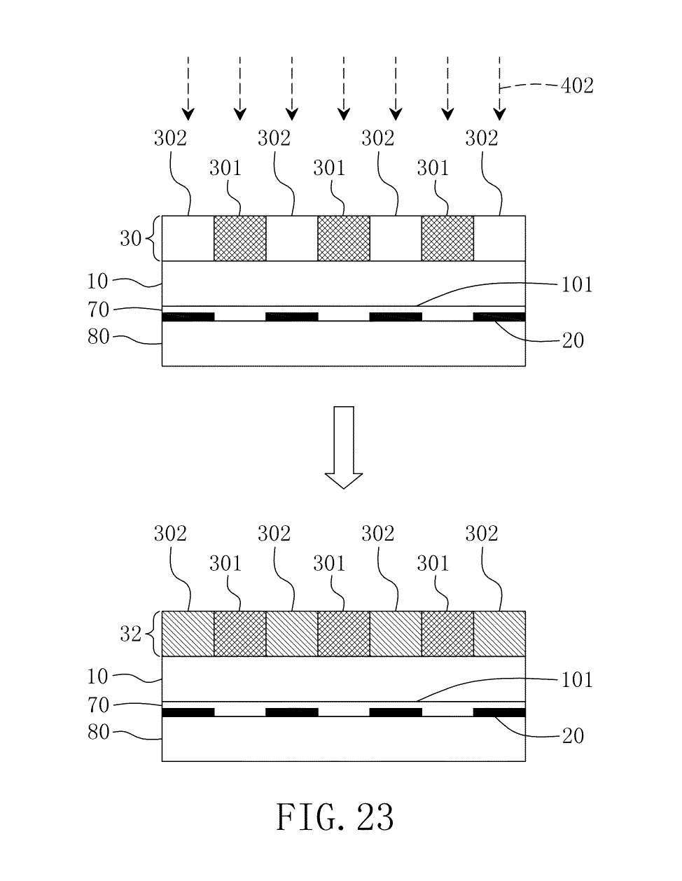

From the results of Comparative Examples A1 and A3 shown in Table 1, it was found that when the slow axis of the second light-transmissive substrate formed an angle of 0° with respect to the polarizing direction of the first linearly-polarized ultraviolet light, and when the sum of a first retardation value of the first light-transmissive substrate and a second retardation value of the second light-transmissive substrate was not less than 300 nm, the liquid crystal molecules of the liquid crystal material layer in those comparative examples could only be aligned in one state of orientation. This is because that the first linearly-polarized ultraviolet light was converted to circularly-polarized ultraviolet light after passing through the first and the second light-transmissive substrates. The first regions of the photo-orientable layer exposed to the circularly-polarized ultraviolet was simply cured but not oriented in desired directions (See FIG. 22). When the photo-orientable layer was subsequently exposed to the second linearly-polarized ultraviolet light, only the second regions were oriented in the second orientation direction because the first regions were cured already (See FIG. 23). Thus, the photo-orientable layer was not transformed into a photo-alignment layer which should have two oriented regions that are oriented in two different directions, respectively.

From the results of Examples A4 and A8 shown in Table 1, it was found that when the slow axis of the second light-transmissive substrate formed an angle of +45° with respect to the polarizing direction of the first linearly-polarized ultraviolet light, and when the sum of a first retardation value of the first light-transmissive substrate and a second retardation value of the second light-transmissive substrate was less than 100 nm, the liquid crystal molecules of the liquid crystal material layer can be aligned in two different states of orientation. This means that the photo-alignment layer in each of those examples had two oriented regions that were respectively oriented in two different directions.

From the results of Comparative Examples A2 and A4 shown in Table 1, it was found that when the slow axis of the second light-transmissive substrate formed an angle of +45° with respect to the polarizing direction of the first linearly-polarized ultraviolet light, and when the sum of a first retardation value of the first light-transmissive substrate and a second retardation value of the second light-transmissive substrate was not less than 100 nm, the liquid crystal molecules of the liquid crystal material layer in those comparative examples could only be aligned in one state of orientation. This is because the first linearly-polarized ultraviolet light was converted to circularly-polarized ultraviolet light after passing through the first and the second light-transmissive substrates. Thus, Comparative Examples A2 and A4 showed similar results to those of Comparative Examples A1 and A3.

### Example B1 (EX B1)

A patterned retarder of Example B1 was made according to the process employed in Example A1, except that the weight ratio of the ultraviolet absorbing agent to the binder was 1:37.5 in forming the ink material.

### Example B2 (EX B2)

A patterned retarder of Example B2 was made according to the process employed in Example B1, except that the weight ratio of the ultraviolet absorbing agent to the binder was 1:50 in forming the ink material.

### Example B3 (EX B3)

A patterned retarder of Example B3 was made according to the process employed in Example B1, except that the patterned photomask layer was formed by sputtering a chromium layer on the first light-transmissive substrate, followed by laser-etching the chromium layer to remove undesired portions of the chromium layer.

### Example B4 (EX B4)

A patterned retarder of Example B4 was made according to the process employed in Example B1, except that the patterned photomask layer was formed by applying 1 g of a black ink (purchased from Taipolo Technology Co., Ltd, Taiwan), using a gravure printing technique, to a surface of the first light-transmissive substrate, and thereby forming a predetermined pattern with a printed thickness of 2 μm thereon, followed by baking in an oven at 60° C. for 30 seconds.

The light transmissibility of the light-shielding regions of the patterned photomask layer of each of the patterned retarders of Examples A1, B1 to B4 was evaluated. In addition, the orientation state of each of the patterned retarders of Examples B1 to B4 was further analyzed using the birefringence analyzer (manufactured by Oji Scientific Instruments, trade name: KOBRA-CCD). The measured results are shown in Table 2.

TABLE 2

| | | Light | |
|---|---|---|---|
| | | transmissibility of | |
| | Material for | the light-shielding | |
| | forming the | regions of the | Number of |
| | patterned | patterned | orientation |
| | photomask layer | photomask layer | states |
| EX A1 | A:B* = 1:25.0 | 10% | 2 |
| EX B1 | A:B = 1:37.5 | 15% | 2 |
| EX B2 | A:B = 1:50.0 | 20% | 2 |
| EX B3 | Chromium | 0% | 2 |
| EX B4 | Black ink | <1% | 2 |

*A:B represents a weight ratio of the ultraviolet absorbing agent to the binder.

From the results shown in Table 2, it is found that even when the light transmissibility of the light-shielding regions of the patterned photomask layer was as high as 20%, the liquid crystal molecules of the liquid crystal material layer can be aligned in two different states of orientation.

### Comparative Example C1(CE C1)

A patterned retarder of Comparative Example C1 was made according to the process employed in Example A1, except that steps (3) to (5e) were replaced by the following steps (3C) to (5Cb). In this comparative example, the patterned photomask layer was substituted by a quartz mask, and thus the first light-transmissive substrate was omitted.

(3C) Preparation of a Photo-Orientable Layer

Step (3C) is similar to step (5b) of Example A1, except that the second light-transmissive substrate in step (3C) was not bonded to a first light-transmissive substrate.

(4C) Providing a Quartz Mask

A quartz mask was used to serve as the patterned photomask layer and was prepared by sputtering a layer of chromium on a quartz glass substrate, and etching the chromium layer to obtain a pattern substantially the same as the pattern of the patterned photomask layer of Example A1. The quartz mask was then disposed on the photo-orientable layer through a spacer to be spaced apart from the photo-orientable layer by a distance of 200 μm so as to avoid any undesired effect caused by contact between the quartz mask and the photo-orientable layer.

(5C) Preparation of a Patterned Retarder

(5Ca) First Irradiation Using Second Linearly-Polarized Ultraviolet Light

The photo-orientable layer was exposed to second linearly-polarized ultraviolet light through a plurality of light-transmissive regions of the quartz mask at an accumulated exposure dose of 180 mJ/cm². The slow axis of the second light-transmissive substrate formed an angle of 90° with respect to a polarizing direction of the second linearly-polarized ultraviolet light. The second linearly-polarized ultraviolet light was uncollimated light. In this step, a plurality of first regions of the photo-orientable layer were exposed to the second linearly-polarized ultraviolet light.

(5Cb) Second Irradiation Using First Linearly-Polarized Ultraviolet Light

The photo-orientable layer was exposed to first linearly-polarized ultraviolet light through the second light-transmissive substrate at an accumulated exposure dose of 90 mJ/cm². The slow axis of the second light-transmissive substrate formed an angle of 0° with respect to a polarizing direction of the first linearly-polarized ultraviolet light. The first linearly-polarized ultraviolet light was uncollimated light. In this step, a plurality of second regions of the photo-orientable layer and the first regions of the photo-orientable layer were exposed to the first linearly-polarized ultraviolet light, thereby transforming the photo-orientable layer into a photo-alignment layer which had two different orientation directions.

(5Cb) Removal of the Quartz Mask

The quartz mask and the spacer were removed.

### Comparative Example C2 (CE C2)

A patterned retarder of Comparative Example C2 was made according to the process employed in Comparative Example C1, except that steps (4C) to (5Cb) were replaced by the following steps (4C2) to (5C2b).

(4C2) First Irradiation Using First Linearly-Polarized Ultraviolet Light

The photo-orientable layer was exposed to first linearly-polarized ultraviolet light through the second light-transmissive substrate at an accumulated exposure dose of 90 mJ/cm². The slow axis of the second light-transmissive substrate formed an angle of 0° with respect to a polarizing direction of the first linearly-polarized ultraviolet light. The first linearly-polarized ultraviolet light was uncollimated light. In this step, a plurality of first regions and a plurality of second regions of the photo-orientable layer were exposed to the first linearly-polarized ultraviolet light.

(5C2a) Providing a Quartz Mask

Step (5Ca2) was substantially the same as step (4C) of Comparative Example C1.

(5C2b) Second Irradiation Using Second Linearly-Polarized Ultraviolet Light

The photo-orientable layer was exposed to second linearly-polarized ultraviolet light through a plurality of light-transmissive regions of the quartz mask at an accumulated exposure dose of 90 mJ/cm². The slow axis of the second light-transmissive substrate formed an angle of 90° with respect to a polarizing direction of the second linearly-polarized ultraviolet light. The second linearly-polarized ultraviolet light was uncollimated light. In this step, the first regions of the photo-orientable layer were exposed to the second linearly-polarized ultraviolet light, thereby transforming the photo-orientable layer into a photo-alignment layer which had two different orientation directions.

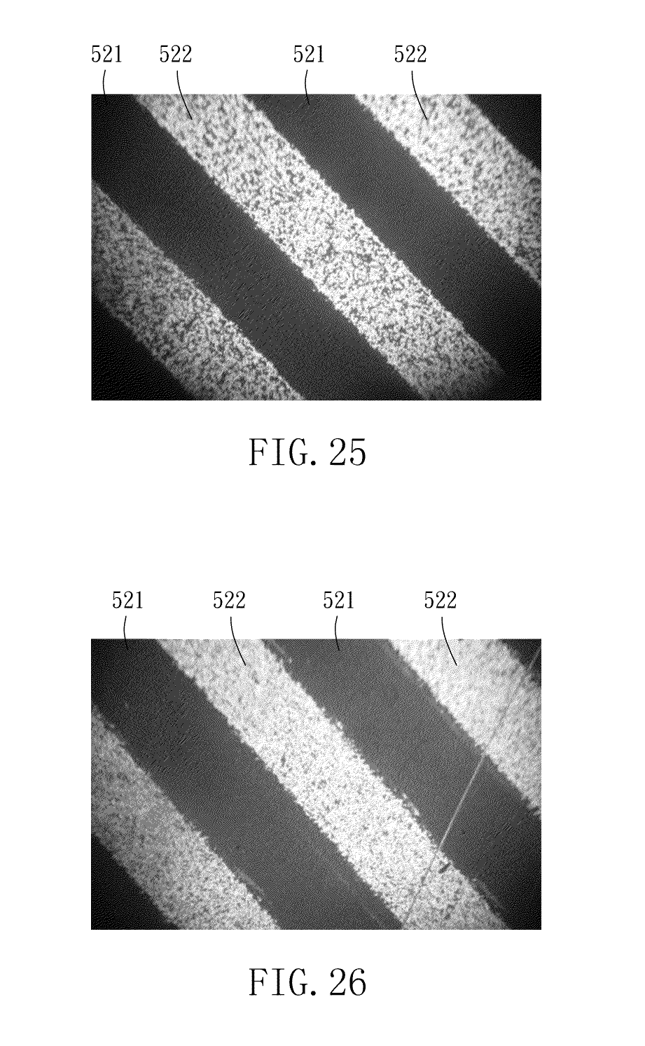

The patterned retarders of Comparative Examples C1 and C2 were observed using a polarized microscope. FIGS. 25 and 26 respectively show the polarized microscope images of the patterned retarders of Comparative Examples C1 and C2. As shown, liquid crystal molecules of the liquid crystal material layer, which were applied onto the second regions of the photo-alignment layer, were not oriented, and a boundary between the first and the second liquid crystal regions (denoted by numerals “521” and “522”) of the liquid crystal material layer was not clear. Because the second linearly-polarized ultraviolet light passing through the quartz mask and a gap between the quartz mask and the photo-alignment layer to irradiate the first regions of the photo-alignment layer was uncollimated light, and the quartz mask was spaced apart from the photo-orientable layer by a relatively large distance (200 μm), a part of the second linearly-polarized ultraviolet light was diffused to the second regions of the photo-alignment layer which were covered by the predetermined pattern, so that edges of the second regions of the photo-alignment layer were exposed to the diffused second linearly-polarized ultraviolet light. In addition, because of such diffusion of the light, the orientation direction of the second regions of the photo-alignment layer was likely to be influenced, so that orientation direction of the second liquid crystal regions resulted in a disordered direction. Because the orientation direction was disordered, the state of orientation of the second liquid crystal regions was not observed clearly by the polarized microscope, as shown in FIGS. 25 and 26 respectively.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for fabricating a patterned retarder, comprising:
(a) providing a first light-transmissive substrate having two opposite surfaces, any one of the surfaces including a pressure-sensitive adhesive layer which is light-transmissive, any one of the surfaces including a patterned photomask layer having a plurality of light-transmissive regions in linear alignment, and a plurality of light-shielding regions which alternate with the light-transmissive regions;
(b) providing a second light-transmissive substrate having opposite front and rear surfaces;
(c) bonding the front surface of the second light-transmissive substrate to the pressure-sensitive adhesive layer of the first light-transmissive substrate so that the second light-transmissive substrate is attached to the first light-transmissive substrate;
(d) forming a photo-orientable layer on the rear surface of the second light-transmissive substrate;
(e) irradiating the photo-orientable layer with first linearly-polarized ultraviolet light through the second light-transmissive substrate in a direction from the front surface toward the rear surface of the second light-transmissive substrate to cause a plurality of first regions of the photo-orientable layer to be oriented in a first orientation direction by being irradiated with the first linearly-polarized ultraviolet light that passed through the light-transmissive regions while leaving intact a plurality of second regions of the photo-orientable layer, which are shielded by the light-shielding regions;
(f) irradiating the photo-orientable layer with second linearly-polarized ultraviolet light which is different in polarizing direction from the first linearly-polarized ultraviolet light to cause the second regions of the photo-orientable layer to be oriented in a second orientation direction different from the first orientation direction, so as to transform the photo-orientable layer into a photo-alignment layer which has the first and the second regions each having different orientation directions;
(g) applying a layer of liquid crystal material onto the photo-alignment layer to permit a plurality of first liquid crystal regions of the liquid crystal material layer to be superimposed on and aligned by the oriented first regions, respectively, so as to be in a first state of orientation, and to permit a plurality of second liquid crystal regions of the liquid crystal material layer to be superimposed on and aligned by the oriented second regions, respectively, so as to be in a second state of orientation; and
(h) curing the liquid crystal material layer;
wherein the steps (b) and (c) are performed before the step (e).

2. The method of claim 1, further comprising the step (i) of after performed the step (e), removing the first light-transmissive substrate from the second light-transmissive substrate by detaching the pressure-sensitive adhesive layer from the front surface of the second light-transmissive substrate.

3. The method of claim 2, wherein the step (i) is performed before the step (h).

4. The method of claim 2, wherein the step (i) is performed before the step (f).

5. The method of claim 1, wherein the steps (b) and (c) are performed after the step (f).

6. The method of claim 2, wherein the steps (b) and (c) are performed after the step (f).

7. The method of claim 1, wherein
the step (e) is performed before the step (f), the photo-orientable layer being exposed to the first linearly-polarized ultraviolet light in step at a first accumulated exposure dose and being exposed to the second linearly-polarized ultraviolet light in step (f) at a second accumulated exposure dose smaller than the first accumulated exposure dose such that the first regions remain being oriented in the first orientation direction when exposed to the second linearly-polarized ultraviolet light in step (f).

8. The method of claim 1, wherein the step (e) is performed after the step (f), the photo-orientable layer being exposed to the first linearly-polarized ultraviolet light in step (e) at a first accumulated exposure dose and being exposed to the second linearly-polarized ultraviolet light in step (f) at a second accumulated exposure dose not greater than the first accumulated exposure dose such that the first regions are oriented in the first orientation direction when exposed to the first linearly-polarized ultraviolet light in step (e).

9. The method of claim 1, wherein, in step (f), the photo-orientable layer is directly irradiated by the second linearly-polarized ultraviolet light.

10. The method of claim 1, wherein, in step (f), the photo-orientable layer is irradiated by the second linearly-polarized ultraviolet light through the first light-transmissive substrate in a direction from the front surface toward the rear surface of the second light-transmissive substrate.

11. The method of claim 1, wherein each of the first and the second light-transmissive substrates is made of a material selected from the group consisting of a polyester-based resin, a acetate-based resin, a polyethersulfone-based resin, a polycarbonate-based resin, a polyamide-based resin, polyimide-based resin, a polyolefin-based resin, an acrylic-based resin, a polyvinyl chloride-based resin, a polystyrene-based resin, a polyvinyl alcohol-based resin, a polyarylate-based resin, a polyphenylene sulfide-based resin, a polyvinylidene chloride-based resin, and a methacrylate-based resin.

12. The method of claim 1, wherein each of the first and the second light-transmissive substrates is made of a material selected from the group consisting of cellulose triacetate and polycarbonate.

13. The method of claim 1, wherein when the slow axis of the second light-transmissive substrate forms an angle of 0° or 90° with respect to a polarizing direction of one of the first linearly-polarized ultraviolet light and the second linearly-polarized ultraviolet light, a sum of a first retardation value of the first light-transmissive substrate and a second retardation value of the second light-transmissive substrate is less than 300 nm.

14. The method of claim 1, wherein when the slow axis of the second light-transmissive substrate forms an angle of 45° with respect to a polarizing direction of one of the first linearly-polarized ultraviolet light and the second linearly-polarized ultraviolet light, a sum of a first retardation value of the first light-transmissive substrate and a second retardation value of the second light-transmissive substrate is less than 100 nm.

15. The method of claim 1, wherein the light-shielding regions of the patterned photomask layer are constituted by a material including at least one of an ultraviolet radiation absorbing agent and a light-shielding ink.

16. The method of claim 1, wherein a polarizing direction of the first linearly-polarized ultraviolet light is perpendicular to a polarizing direction of the second linearly-polarized ultraviolet light.
